(19) United States
(12) Patent Application Publication
(10) Pub. No.: US 2026/0205487 A1
(43) Pub. Date: Jul. 16, 2026

(54) SUB-RESOURCE INTEGRITY GENERATION AT A CONTENT MANAGEMENT SYSTEM LEVEL

(71) Applicant: International Business Machines Corporation, Armonk, NY (US)

(72) Inventors: Mauro Marzorati, Lutz, FL (US); Paul Llamas Virgen, Guadalajara (MX); Martin G. Keen, Cary, NC (US)

(21) Appl. No.: 19/020,068

(22) Filed: Jan. 14, 2025

(51) Int. Cl. H04L 9/40

(52) U.S. Cl. CPC H04L 63/1433; H04L 63/1466

(57) ABSTRACT

Mechanisms are provided to evaluate changes to resources as to whether they are likely malignant or benign. The mechanisms detect a code change of a resource and process, by a first artificial intelligence (AI) computer model, features of the detected code change to generate a classification of the code change as being either functional or non-functional. In response to the code change being classified as functional, the mechanisms generate, by a second AI computer model, a natural language narrative description of the code change which is processed by a third AI computer model to extract features based on a computer natural language processing (NLP) to determine a threat level of the code change. The mechanisms either register or deny registration of the code change in a content management system (CMS) based on the threat level of the code change.

### BACKGROUND

The present application relates generally to a data processing apparatus and method and more specifically to a computing tool and computing tool operations/functionality for sub-resource integrity generation at a content management system level.

Websites sometimes utilize third parties or Content Delivery Networks (CDNs) to host resources for these websites rather than having to host these resources themselves. However, using third parties or CDNs introduces a risk that an attacker may gain control of the third party or CDN and make modifications, such as injecting malicious content, into the files hosted by the third party or CDN. In this way, the attacker may attack the various websites that rely on the files hosted by the third party or CDN.

To address such issues, Sub-Resource Integrity (SRI) mechanisms have been provided to check the integrity of such files. SRI is a mechanism to ensure HyperText Markup Language (HTML) content is protected by enabling web browsers to verify that resources they fetch are delivered without unexpected manipulation. SRI works by using a cryptographic hash that a fetched resource must match. In the event that an attacker overtakes the web files that are delivered through a third-party server, or a Content Delivery Network (CDN), and attempts to conduct malicious changes, compatible browsers using SRI will detect that the files have been altered because the hashes of the web files will not match up with the correct cryptographic hashes. However, SRI mechanisms are purposely brittle in that any unacknowledged change, which may be benign, causes a failure.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided that comprises detecting a code change in code of a resource, and processing, by a first artificial intelligence (AI) computer model, features of the detected code change as input to generate a classification of the code change as being either functional or non-functional. The method further comprises, in response to the code change being classified as functional, generating, by a second AI computer model, a natural language narrative description of the code change. The method also comprises processing, by a third AI computer model, the natural language narrative to extract features based on a computer natural language processing (NLP) of the natural language narrative to determine a threat level of the code change. Moreover, the method comprises registering or denying registration of the code change in a content management system (CMS) based on the threat level of the code change.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of an operation of a Sub-Resource Integrity (SRI) artificial intelligence (AI)-based monitor in accordance with one illustrative embodiment;

FIG. 2 is an example diagram of a distributed data processing system environment in which aspects of the illustrative embodiments may be implemented and at least some of the computer code involved in performing the inventive methods may be executed;

FIG. 3 is an example block diagram illustrating the primary operational components of a SRI AI-based monitor in accordance with one illustrative embodiment; and

FIG. 4 is a flowchart outlining an example operation of an SRI AI-based monitor in accordance with one illustrative embodiment.

### DETAILED DESCRIPTION

The illustrative embodiments provide a computing tool and computing tool operations/functionality for sub-resource integrity (SRI) generation at a content management system (CMS) level. The illustrative embodiments are specifically directed to solving problems identified in SRI technology, as discussed hereafter, provide a solution that provides automatic updating of SRI validation hashes in a CMS, and provides intelligent management of referenced content to detect functional changes that are malicious in intent while keeping referencing resource's included hash values updated for non-functional or benign changes.

As noted above, SRI mechanisms are purposefully brittle with any changes to third party or CDN hosted resources, which cause mismatches in cryptographic hashes when performing SRI checks, causing browser rendering of the websites to fail as those resources cannot be retrieved from the third parties or CDNs. This is purposeful to protect the website and those accessing the website from malicious content that an attacker may have injected in the changes to the resources.

Services, such as SRI-Notify, have been developed that aim to manage such changes to resources by alerting subscribers when a monitored resource changes, so that they may take appropriate action. SRI-Notify is a tool that proactively monitors all SRI links on a website and compares the hash values automatically. If any of the SRI links fail validation, an alert is generated so that the website owner can assess the changes to the files associated with the SRI links and determine how to respond.

This externalized monitor service approach suffers from a number of drawbacks. One drawback is that the service itself may be fooled into not detecting the malicious change. For example, an attacker could potentially fool the SRI monitoring service through hash collision attacks, which is where the attacker crafts malicious content that generates the same hash as the original content. In some cases, the attacker can fool the service through man-in-the-middle attacks, where the attacker intercepts and modifies the service's requests while returning the expected hash values.

Another drawback is that a large volume of alerts may be generated when resources are changed and those changes are made through benign processes. That is, the SRI based monitoring services are not able to distinguish between changes that are benign and those that are malicious. Thus, there is a need for an improved computing tool and improved computing tool operations/functionality that addresses these drawbacks in existing technology. The illustrative embodiments provide computing mechanisms that address these drawbacks and provide CMS level capabilities to provide SRI generation that cannot be easily fooled by attackers and which distinguishes between benign and malicious changes so as to minimize the generation of alerts.

The illustrative embodiments provide an improved computing tool and improved computing tool operations/functionality that protect against malicious alterations of third-party content in managed web pages. With the mechanisms of the illustrative embodiments, the credentials for a third party content server (TLS certificate hash, DNS resolution chain, and/or the like) are configured and hardcoded into a monitoring subprocess. The mechanisms of the illustrative embodiments discover and reverse-inventory, through analysis of content by the CMS, sub-resources to their referencing base page.

Periodic validation of watched sub-resource content is performed with local storage of known-good content. Upon detecting a change in a sub-resource, a change analysis is performed to characterize functional and non-functional changes in the sub-resource codebase, e.g., change in spacing (non-functional) versus a change in the actual code (functional). The change analysis includes the creation of a natural language narrative that describes the detected change which is then evaluated to ascertain whether there are indications of maliciousness in the detected change. Upon validation that detected change is benign, the new hash value is updated within the CMS and published and, optionally, caches may be flushed.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides an artificial intelligence based Sub-Resource Integrity (SRI) monitor that generates natural language narratives for changes to resources and evaluates these narratives with artificial intelligence (AI) based sentiment analysis to determine whether the changes are benign or malicious. The monitor then generates alerts for only those changes determined to be malign and updates cryptographic hashes for those determined to be benign, so as to minimize the number of alerts generated. The improved computing tool implements mechanism and functionality, such as SRI AI-based monitor, which cannot be practically performed by human beings either outside of, or with the assistance of, a technical environment, such as a mental process or the like. The improved computing tool provides a practical application of the methodology at least in that the improved computing tool is able to distinguish between benign and malicious changes to resources, both of which cause SRI checks to fail, and provide alerts only for malicious changes and perform appropriate updating of cryptographic hashes and other functionality for benign changes.

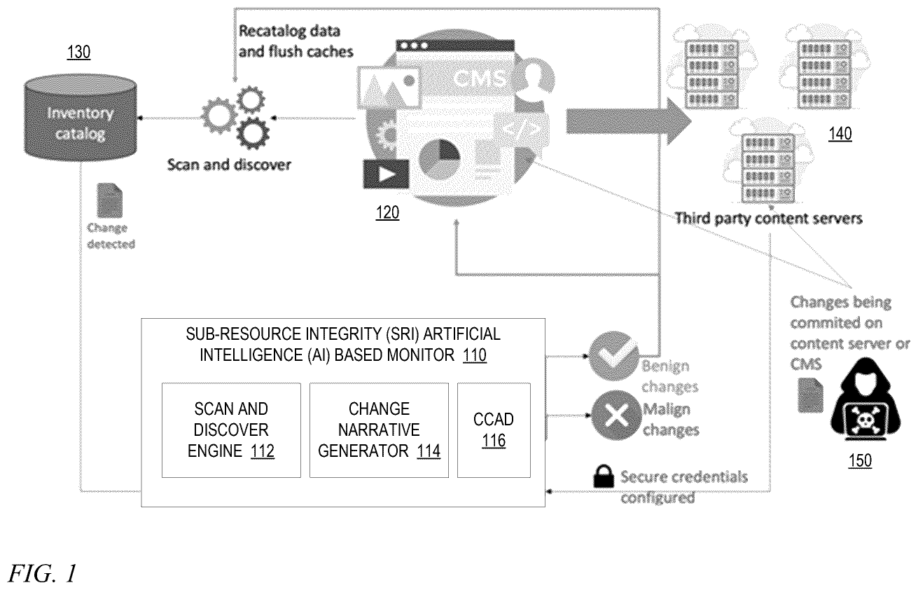

FIG. 1 is an example diagram of an operation of a Sub-Resource Integrity (SRI) artificial intelligence (AI)-based monitor in accordance with one illustrative embodiment. FIG. 1 depicts a basic scenario in which there is one content management system (CMS) 120 of content associated with a group of third party content provider computing systems 140, as well as one single inventory catalog 130, where the inventory catalog 130 is an inventory of all the files that are under management/control. It should be appreciated this may be scaled up to scenarios where there are multiple CMS 120 and multiple inventory catalogs 130 and third party content provider computing system groups 140.

As shown in FIG. 1, a SRI AI-based monitor 110 is provided as part of, or working in conjunction with, a content management system (CMS) 120. The CMS 120 is a computing system that manages the creation and modification of digital content, such as for enterprise content management (ECM) or web content management (WCM). The CMS 120 comprises a front-end user interface, referred to as the content management application (CMA) through which users can add, remove, and modify content from websites, and a content delivery application (CDA) that compiles the content and updates the website. The CMS 120 may be an on-premises installation or a cloud based installation. The CMS 120 provides indexing, searching, and retrieval functionalities whereby one may search by attributes, such as publication dates, keywords, author, and the like, an inventory catalog 130 to find resources for building websites. The resources themselves may be provided, and may reside with, third party content provider computing systems 140.

The CMS 120 may be utilized by users of the third party content provider computing systems 140 to create and modify content that is then cataloged in the inventory catalog 130. Hence, these third party content provider computing systems 140 and the CMS 120 represent a potential portal through which bad actors 150 may make malicious changes to content which may then be used by websites unknowingly. In this way, the bad actor 150 may attack websites via injecting malicious code into the content that is then retrieved by browsers when rendering the website at client computing systems.

The CMS 120 scans the content (resources) provided by the third party content provider computing systems 140 and generates an inventory catalog 130. In the illustrative embodiments, the content or resources may be any data structures, files, or the like, which represent content that may be used to create websites and web pages of websites, e.g., image files, audio files, textual files, multimedia files, and the like. While the illustrative embodiments are described in the context of websites and web pages, the illustrative embodiments are not limited to such and may be implemented to detect malicious changes in other controlled content.

The inventory catalog 130 comprises a record of every resource, e.g., file, and its metadata, which is provided by the third party content provider computing systems 140 for use with website building via the CMS 120. By scanning the inventory catalog 130 on a periodic or continuous basis, the scan and discover engine 112 can discover new and updated resources created by third parties 140 via the CMS 120. Thus, as resources are created via the CMS 120, the scan and discover engine 112 creates records in the inventory catalog 130. Similarly, as resources are modified via the CMS 120, these modifications likewise cause an update to the inventory catalog 130 to update the corresponding records with the new record information and metadata for the resource.

When a change to a resource is detected in the inventory catalog 130, such as when a new resource is added or when an existing resource is modified, this change is detected by the scan and discover engine 112 of the SRI AI-based monitor 110. These changes may be identified in various ways. As one example, the changes may be identified by using a customized version of the Unix “diff” command to extract line-by-line changes in the source code. The “diff” command identifies alterations such as added, removed, or modified lines of code. It should be appreciated that this is only one example and other tools for identifying differences between code may be used without departing from the spirit and scope of the present invention.

A change to the inventory catalog 130 triggers a change narrative generator 114 of the SRI AI-based monitor 110. Moreover, the scan and discover engine 112 may also be informed of changes that may be performed at the third party content provider computing systems 140 which are then logged in the inventory catalog 130. That is, changes may be identified by the scan and discover engine 112 whether at the inventory catalog 130 or the third party content provider computing systems 140.

The change narrative generator 114 operates to prevent malicious code, which may be injected by bad actors 150, from being pushed to client websites that reference these resources. The change narrative generator 114 is triggered by changes on the third party content provider computing systems 140 or the CMS 120 as indicated by changes in the inventory catalog 130. The scan and discover engine 112 discovers changes and classifies the changes as to whether they are functional or non-functional by performing a content analysis of the changed content using one or more first AI computer models. For example, in the following code there is a benign change in which the change is non-functional:
original code: Int sum(int a, int b){(provided by authenticated source)
changed code: Int sum(int a, int b){

As can be seen from this example, the change is merely to add an additional space to the code which does not cause any change in the functionality of the code. Thus, this type of change would be classified by the change narrative generator 114 as being non-functional. Non-functional changes are assumed to be benign changes as they provide no change to the actual functionality of the code itself and hence, are most likely not an attempt by a bad actor 150 to inject some malicious code.

In another example, as shown below, the change may be determined to be functional and may further be determined to be from an non-authenticated source. A change from a non-authenticated source may be assumed to be malignant and may be flagged as such. For example, consider the example change:
original code: Int sum(int a, int b){(provided by authenticated source)
changed code: Int sum(int a, int b, int c){(The sum function's interface now has a new parameter)

Thus, this example change represents a change in the code structure and is identified as modifying the functionality of the code. Moreover, this change is not from an authenticated source and thus, is classified as both functional and malignant.

The scan and discover engine 112 may detect changes in the source code for a resource and may then utilize its first AI computer model(s) to classify the changes as to whether they are functional (altering control flow or data structures) or non-functional (e.g., formatting and the like). For those changes that are determined to be functional, the change narrative generator 114 may implement one or more second AI computer models that interpret the classified changes to generate a narrative describing those changes in a natural language description. For example, if a first AI computer model of the scan and discover engine 112 classifies a change as adding a parameter to a function, the second AI computer model of the change narrative generator 114 may use this classification and other information about the particular function where the change was detected, and the like, to generate a narrative description of the type “The function sum now requires an additional integer parameter to accommodate the new feature of cumulative addition.” The generation of a natural language narrative in this manner facilitates the use of transformer-based natural language processing (NLP) AI computer models to perform further analysis and operations to determine whether the changes are benign or malignant in nature.

The SRI AI-based monitor 110 further comprises an change classification and anomaly detector (CCAD) 116 that operates on the narrative generated by the change narrative generator 114 to evaluate how typical the change described in the narrative is. A change that introduces an unusual or complex new function, deviating significantly from historical patterns of the resources may trigger generation of a higher anomaly score and suggest potential maliciousness. A change that does not deviate significantly from the historical patterns of the resources may be flagged, logged, or the like, and notifications may be generated, but may not be indicated as necessarily being malicious.

The CCAD 116 receives as input the narrative generated by the change narrative generator 114. The CCAD 116 pre-processes the received narrative by tokenizing the narrative into portions of text, e.g., words, phrases, or the like. The tokens are converted to a standard format, e.g., lowercasing, removing special characters, and the like, through a normalization process.

The CCAD 116 generates a set of features from the tokenized narrative, where these features include keywords associated with new code feature mentions in the narrative, features indicative of complexity, or features indicative of unusual patterns. The particular features extracted may be based on the particular tools used, but in general are features that describe what a particular piece of code is doing. The illustrative embodiments leverage these tools to extract these features.

The extracted features from the narrative are input to one or more AI computing models that perform a classification on the set of input features to classify the changes described in the narrative as to whether they are malign or benign. The AI computing model(s) is trained through a machine learning training process on training data comprising examples of narratives and corresponding ground truth labels specifying a proper classification of the changes described in the examples of narratives. Through the training, the AI computing model(s) is trained to recognize patterns of input features that correspond to malign and/or benign changes to code as described in narratives. The AI computing model(s) may output a binary classification, e.g., 0 for benign and 1 for malign, or may generate a score indicating a risk that the changes described in the narrative are malignant or benign, e.g., a percentage value or some other risk scale suitable to the particular implementation. Malignant changes introduce unexpected or harmful alterations to the code and benign changes represent standard or expected changes or changes that do not appreciably affect the functionality of the code.

The CCAD 116 performs a threat assessment based on the classification of the changes in the narrative. This threat assessment may comprise, for changes determined to be malignant, comparing the classified changes against a database of known code change patterns, e.g., known vulnerabilities or known acceptable modifications, to calculate a threat score. The pattern matching may operate by extracting key code entities and operations from the narrative, e.g., things like “added parameter”, “modified return value”, and the like, and comparing them against known patterns using semantic similarity matching. The database of known patterns may be initially seeded with common vulnerability patterns and updated through user validation feedback.

The threat score may be calculated using a weighted formula, for example. In some illustrative embodiments, that formula may contain an Anomaly_Score, a Pattern_Match_Score, a Source_Auth_Score, and a Historical_Deviation_Score. Multiple scores may be used with each score capturing different aspects of the change. For example, the initial classification provides an indication that further analysis is needed, the Anomaly_Score captures novel threats, and the Pattern_Match_Score captures known malicious patterns. The Anomaly_Score indicates how different the change is from expected changes. The Pattern_Match_Score indicates how much the code change matches known patterns indicative of malicious code. The Source_Auth_Score indicates how reliable the source of the code change is. The Historical_Deviation_Score indicates how much the code change deviates from previous historical code changes made to resources.

One example weighted formula may be of the type:

Threat_Score=(0.4 * Anomaly_Score)+(0.3 * Pattern_Match_Score)+(0.2 * Source_Auth_Score)+(0.1 * Historical_Deviation_Score)

Thus, the threat score may be calculated based on various factors, such as an evaluation of how typical the change is, e.g., how significantly the change deviates from the historical changes for the same resource or set of related resources, the nature of the change classification, e.g., functional/non-functional, whether metadata indicates the change was from a known (authorized) source or not, etc. Each score, such as those mentioned above, serves a complementary security purpose. The classification identifies functional changes that require deeper analysis, the anomaly score detects novel or unexpected deviations from normal patterns, and the threat score combines all evidence (including pattern matching and source authentication) to make a final determination about maliciousness. In this way, there is an accounting for both known and unknown threats being detected while minimizing false positives.

Based on the threat score, the changes described in the narrative are either permitted to be stored and utilized to generate websites or web pages by browsers, or they are not. For example, if the threat score is equal to or above a threshold, it is determined that the change is a potential malignant change and thus, will not be permitted to be used by the CMS 120 to build or update websites and will not be maintained in the inventory catalog 130. In some illustrative embodiments, this may further involve sending an alert notification to administrators of the third party content provider computing systems 140 informing them of the potential breach of their security, as well as any website owners that utilize the changed resource.

However, if the change is determined to be benign, or the threat score is below the threshold, then the change is permitted to be made and the changed code may be used to update the inventory catalog 130 and may be used by the CMS 120 to build websites and render them. This may involve re-cataloging the resource in the inventory catalog 130 and flushing caches of the CMS 120 so that the CMS 120 will retrieve the new version of the resource at the next usage instance and store it in the cache.

In some illustrative embodiments, a feedback loop is implemented which is used to improve future analysis by the SRI AI-based monitor 110. This feedback loop includes mechanisms through which users may review the generated narratives of the change narrative generator 114 and classifications made by the CCAD 116, and provide feedback inputs that specify the correctness/incorrectness of these generated outputs. This information may be fed back into the AI computer models of the change narrative generator 114 and CCAD 116 as additional training examples with corresponding ground truth labels generated based on the user feedback input. Thus, for example, if a narrative is specified by the user feedback to be incorrect, the user can provide a correct narrative and this may be used as the ground truth for the inputs that were used to generate the incorrect narrative. This pairing would then be a new training example fed back into the AI computer model of the change narrative generator 114. Similarly, if a change is classified as benign, and the user feedback input indicates it is actually malignant, then this user feedback may be stored as a ground truth label for a new training example, paired with the input features to the AI computer model of the CCAD 116 which caused the incorrect classification. Thus, a continuous or periodic retraining of the AI computer models is made possible so as to keep the AI computer models optimized for their particular functions.

Thus, the illustrative embodiments provide an improved computing tool and improved computing tool operations/functionality that are able to detect and analyze changes to resources at the Content Management System (CMS) level, and determine whether those changes are likely benign or malignant. The illustrative embodiments leverage AI computer models to facilitate this analysis by converting code changes to natural language narratives that describe the changes that were made and then classifying those changes based on an AI computer model analysis of features extracted from the natural language content of the narratives. Threat scores may be calculated based on the classification as well as other characteristics of the change represented in metadata, the pattern of features extracted from the natural language content, and comparisons to a database of known vulnerabilities, historical code changes for the resource or set of related resources, and/or acceptable (normal or expected) code changes. The threat score can then be used to determine an action to take with regard to the change to the code, e.g., accept the code change or reject the code change and prevent usage of the changed code via the CMS.

Thus, the illustrative embodiments provide a Sub-Resource Integrity (SRI) checking capability that addresses the problems of brittleness in the existing SRI mechanisms. The illustrative embodiments utilize AI computing models to distinguish between benign and malignant changes to code, rather than assuming that all changes to code resulting in a mismatch of hashes, and which are unacknowledged changes, are malignant and cause a failure to render the webpage or website.

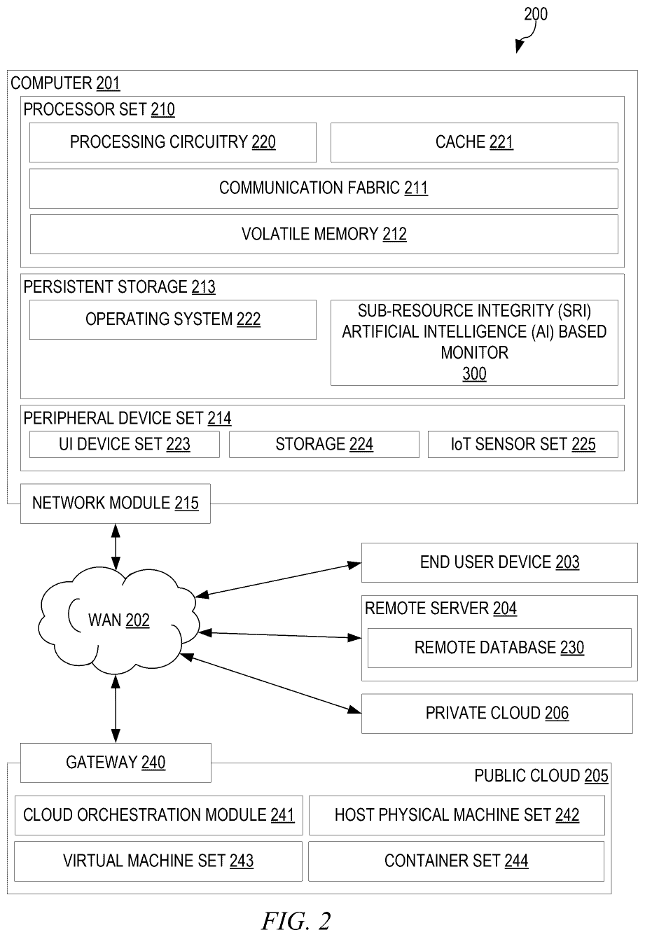

FIG. 2 is an example diagram of a distributed data processing system environment in which aspects of the illustrative embodiments may be implemented and at least some of the computer code involved in performing the inventive methods may be executed. That is, computing environment 200 contains an example of an environment for the execution of at least some of the computer code involved in performing the inventive methods, such as SRI artificial intelligence (AI)-based monitor 300. In addition to SRI AI-based monitor 300, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and SRI AI-based monitor 300, as identified above), peripheral device set 214 (including user interface (UI), device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

Computer 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in SRI AI-based monitor 300 in persistent storage 213.

Communication fabric 211 is the signal conduction paths that allow the various components of computer 201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, the volatile memory is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface type operating systems that employ a kernel. The code included in SRI AI-based monitor 300 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

As shown in FIG. 2, one or more of the computing devices, e.g., computer 201 or remote server 204, may be specifically configured to implement a SRI AI-based monitor 300. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 201 or remote server 204, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates integrity checking of third party hosted resources for websites which minimizes alert notifications to those associated with changes determined to be likely malicious, and which is not easily fooled by an attacker into thinking that no changes were made or that the changes were benign.

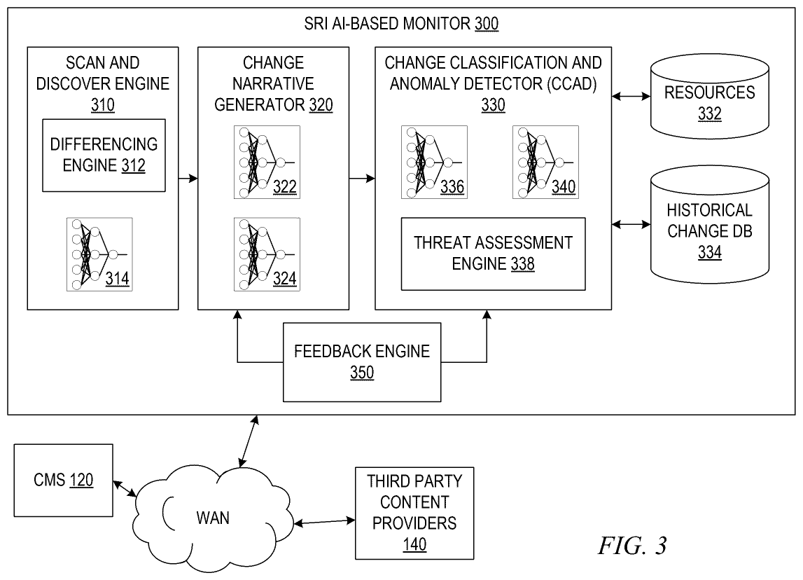

FIG. 3 is an example block diagram illustrating the primary operational components of a SRI AI-based monitor in accordance with one illustrative embodiment. The operational components shown in FIG. 3 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that SRI validations are performed with regard to third party or CDN hosted resources, and providing a specific solution that implements AI-based natural language narrative generation for changes to resources and AI-based classification and anomaly detection that differentiates between benign and malicious changes to resources causing an SRI validation to fail.

As shown in FIG. 3, the Sub-Resource Integrity (SRI) artificial intelligence (AI)-based monitor 300 operates as part of, or in conjunction with, a content management system (CMS), such as CMS 120 in FIG. 1, and an inventory catalog, such as inventory catalog 130 in FIG. 1. The CMS 120 may be utilized by third party content provider computing systems, such as 140 in FIG. 1, to provide resources, i.e., various types of content, for use in building websites, webpages, and the like. The SRI AI-based monitor 300 comprises a scan and discover engine 310 that scans the resources of the inventory catalog 130 and discovers changes to resources in the inventory catalog 130. This may be done on a periodic or continuous basis. In some illustrative embodiments, this may be done in response to a system adding or modifying a resource which is then requested to be added to the CMS 120 resource offerings.

The scan and discover engine 310 comprises a differencing engine 312 which determines differences between versions of code to thereby discover changes. As noted above, in one example implementation, this differencing engine 312 may utilize a customized version of the Unix “diff” command to extract line-by-line changes in the source code of the resource to thereby identify changes and then proceed with the processing by the SRI AI-based monitor 300. Of course, other differencing algorithms or other mechanisms for detecting changes in code may be used without departing from the spirit and scope of the present invention. Completely new code may be considered to be a complete “change” of the code as there is no previous version to compare to. Thus, any specific changes to code or any new code may be further evaluated to determine the nature of the changes or new code.

The scan and discover engine 310 may further include an AI computer model 314 that operates as a classifier to classify the changes detected by the differencing engine 312 as to whether they are functional or non-functional changes. In some illustrative embodiments, the AI computer model 314 may be a support vector machine (SVM), Convolutional Neural Network (CNN), Recurrent Neural Network (RNN), or the like. In some illustrative embodiments, the AI computer model 314 may be a language model (LM) or fine-tuned large language model (LLM) that is specifically trained for classifying code changes, where the “language” operated on is a source code language. With LM/LLMs, these models are fine-tuned for the specific purpose or task that the LM/LLM is supposed to perform. That is, LMs and LLMs are already pre-trained on large volumes of data to understand particular natural language inputs. By fine-tuning these pre-trained LMs/LLMs, the illustrative embodiments are able to leverage the large scale training of the LMs/LLMs, but fine-tune it to the specific task/purpose required, e.g., classification of code changes with regard to them being functional or non-functional in this case.

As with the other AI computer models, the AI computer model 314 may be trained through machine learning training processes to take difference identifications from the differencing engine 312 as inputs and output a classification of whether those differences are functional (e.g., altering control flows or data structures) or non-functional (e.g., adding spaces, changing indentations, or other formatting changes). The classification output may be a binary output of functional or non-functional, or may be a score or probability value that indicates a likelihood that the changes are functional or non-functional.

Thus, as resources are created via the CMS 120, the scan and discover engine 310 creates records in the inventory catalog 130. Similarly, as resources are modified via the CMS 120, these modifications likewise cause an update to the inventory catalog 130 to update the corresponding records with the new record information and metadata for the resource. In each case, these resources may be processed by the SRI AI-based monitor 300 to determine a likelihood that the new or changed code comprises malignant content injected by a bad actor, such as bad actor 150 in FIG. 1, or not.

The SRI AI-based monitor 300 further comprises a change narrative generator 320 comprising one or more narrative generating AI computer models 322-324 that are trained through machine learning training to generate natural language narratives describing changes detected by the scan and discover engine 310. The AI computer models 322-324 may be transformer-based natural language processing AI computer models, for example. In some illustrative embodiments, the narrative generating AI computer models 322-324 may be LMs or a fine-tuned LLM, that is built upon a transformer-type AI computer model, such as a Generative Pre-Trained (GPT) AI computer model or the like. In some illustrative embodiments, rather than hosting the AI computer models 322-324 itself, the SRI AI-based monitor 300 may have interfaces through which the SRI AI-based monitor 300 may access third party or cloud provided AI computer models 322-324 that provide this functionality for generating narratives from identified code changes, e.g., interfaces for submitting prompts, specifying code changes and requesting narrative generation, to a LM/LLM and receiving narratives in response.

The narrative generating AI computer models 322-324 receive features extracted from the detection of source code changes and utilizes these features as input from which natural language descriptions of the changes are generated. In the case of LMs or fine-tuned LLMs, the features may be input to the LM/LLM as part of a prompt using prompt engineering templates or the like. For example, a prompt may be “generate a natural language description of a change in source code using the following context” and the context may be populated with the features, or even the portion of changed code itself, that was identified by the scan and discover engine 310. It should be appreciated that prompts, prompt templates, and prompt engineering are only one example embodiment and the illustrative embodiments are not limited to such. Any suitable mechanism for inputting features to narrative generating AI computer models 322-324 in order to have them generate a natural language narrative comprising a description of code changes represented in the input features may be used without departing from the spirit and scope of the present invention.

The narratives generated by the narrative generating AI computer models 322-324 may be a series of descriptions based on code analysis which will be used as inputs for threat detection. The following are some examples of narratives generated from code changes:

### Example 1

Original code:
def greet_user( ):
   print(“Hello, User!”)
      Changed code:
def greet_user( ):
   print(“Welcome, User!”)

### Narrative:

A low-impact change has been made to the greet_user function. The modification updates the greeting message from “Hello” to “Welcome.” This is a non-functional change as it only alters the displayed string without affecting the logic or structure of the program.

### Example 2

Original code:
def calculate_discount(price, discount_rate):
return price * discount_rate

### Changed Code:

def calculate_discount(price, discount_rate):
return price-(price * discount_rate)

### Narrative:

An important-impact change has been made to the calculate_discount function. The operation within the return statement has shifted from multiplying the price by the discount rate to subtracting the discounted amount from the price. While the function still calculates a discount, this modification alters the behavior, potentially impacting how the discount is applied. It may have downstream effects on dependent functions or calculations.

### Example 3

Original code:
def calculate_total(price, tax_rate):
return price+(price * tax_rate)
   Changed code:
def calculate_total(price, tax_rate):
return price +(price * tax_rate)
def calculate_discount(price, discount_rate):
return price-(price * discount_rate)
def apply_discount_and_tax(price, discount_rate, tax_rate):
discounted_price=calculate_discount(price, discount_rate)
return calculate_total(discounted_price, tax_rate)

Narrative: A high-impact change introduces two new functions: calculate_discount and apply_discount_and_tax. These additions significantly extend the functionality of the original code by enabling combined application of discounts and taxes. The new functions require testing and integration to ensure they operate correctly and do not introduce unintended behavior into the system. This represents a structural expansion of the code, with potential implications for other parts of the program that interact with these functions.

The SRI AI-based monitor 300 further comprises a change classification and anomaly detector (CCAD) 330 that operates on the narrative generated by the change narrative generator 320 to perform natural language processing (NLP) and evaluate how typical the change described in the narrative is, as previously described above.

The CCAD 330 may pre-process the received narrative by tokenizing the narrative into portions of text, e.g., words, phrases, or the like, and then normalizing the tokens to generate a standardized format that may be processed by NLP mechanisms and other logic of the CCAD 330, e.g., lowercasing, removing special characters, and the like. The CCAD 330 generates a set of features from the tokenized and standardized narrative, where these features include keywords associated with new code feature mentions in the narrative, complexity, or unusual patterns.

The CCAD 330 may utilize stored resources 332, such as a knowledge base, database, ontology, or the like, that stores information describing known vulnerabilities that have been exploited by bad actors and/or normal or acceptable code change patterns that are not indicative of malicious intent. Moreover, the CCAD 330 may utilize a historical change database 334 that stores historical change patterns for resources and/or groups of related resources of third party content provider computing systems 140. That is, the historical change database 334 stores version information, changes, and the like, that have been made to resources over time and which have been designated to be benign or authorized. Thus, if similar changes or patterns are performed subsequently with regard to the same or related resources, these changes or patterns may be more likely to be considered benign. If a change is determined to no match these historical changes or patterns, then it is more likely that the change is not benign.

Similar analysis and evaluations can be made with regard to information stored in the resources 332. For example, if a change appears to be directed to the same type of code known to be associated with a particular known vulnerability, the likelihood is that this is a malicious change to the code attempting to exploit that vulnerability. If the change appears to be similar to known benign code patterns, then it is more likely to be a benign change. Thus, by performing a similarity comparison with the resources 332 and the historical change database 334, the CCAD 330 can determine a likelihood, or probability assessment, as to whether a given change is more or less likely to be benign or malignant (malicious).

Such assessment may be made in combination with natural language processing (NLP) analysis of the textual content of the generated narrative itself, e.g., sentiment analysis or the like, by one or more NLP AI computer models 336. That is, sentiment analysis mechanisms of the NLP AI computer models 336 may evaluate the text of the narrative to determine if the text indicates a positive/negative aspect of the change. Additional NLP analysis may include entity identification, synonym analysis, antonym analysis, or any other known or later developed NLP analysis to extract features indicative of the types of changes described in the narrative. The entity identification and other NLP analysis results may be used with the resources 332 and historical change database 334 to match to known patterns and known vulnerabilities to perform the analysis noted above and determine a probability of the change being benign or malignant.

The analysis by the CCAD 330 may identify whether or not the change described in the narrative is one that introduces an unusual or complex new function, deviates significantly from historical patterns of the resources, exploits a known vulnerability, or the like, all of which may trigger generation of a higher malignancy or “anomaly” probability score and suggest potential maliciousness. A change that does not deviate significantly from the historical patterns of the resources, does not introduce any unusual or complex new function, does not exploit a known vulnerability, or corresponds to patterns previously determined to be benign, may be flagged, logged, or the like, and notifications may be generated, but may not be indicated as necessarily being malicious, or may in fact be indicated to be benign.

The extracted features generated by the CCAD 330 through the NLP operations by the NLP AI computer models 336, the matching to resources 332 and historical change database 334, and the like, may be input to an anomaly detection AI computer model 340 as input features. The anomaly detection AI computer model 340 performs a classification on the set of input features to classify the changes described in the narrative as to whether they are malign (anomaly) or benign (not an anomaly). In one or more illustrative embodiments, the anomaly detection AI computer model may be a one-class Support Vector Machine (SVM), for example, which evaluates how typical the change described in the narrative is and outputs an anomaly score that quantifies how usual/unusual the change is. The anomaly detection AI computing model(s) 340 may output a binary classification, e.g., 0 for benign and 1 for malign, or may generate a score indicating a risk that the changes described in the narrative are malignant or benign, e.g., a percentage value or some other risk scale suitable to the particular implementation.

The CCAD 330 further comprises a threat assessment engine 338 that quantifies a level of threat of the changes to the code based on the classification of the changes in the narrative performed by anomaly detection AI computer model 340. This threat assessment may comprise, for changes determined to be malignant, comparing the classified changes against a database of known patterns, e.g., known vulnerabilities or known acceptable modifications as indicated by the data in the resources 332 and historical change database 334, to calculate a threat score. The threat score may be calculated based on factors such as an evaluation of how typical the change is, e.g., how significantly the change deviates from the historical changes for the same resource or set of related resources, the nature of the change classification, e.g., functional/non-functional, whether metadata indicates the change was from a known (authorized) source or not, etc.

Based on the threat score, the SRI AI-based monitor 300 permits or denies the registration of the changed resources with the CMS 120. For example, if the threat score is equal to or above a threshold score, it is determined that the change is a potential malignant change or cannot be authenticated to be benign and thus, will not be permitted to be stored by the CMS 120 and registered with the inventory catalog 130 for building or updating web pages or websites. The SRI AI-based monitor 300 may also send alert notifications to administrators of the third party content provider computing systems 140 informing them of the potential breach of their security, as well as any website owners that utilize the changed resource.

In some illustrative embodiments, the SRI AI-based monitor 300 may further include a feedback engine 350 that provides a feedback loop used to improve future analysis by the SRI AI-based monitor 300. The feedback engine 350 includes user interfaces through which users may review the generated narratives of the change narrative generator 320 and classifications made by the CCAD 330, and provide feedback inputs that specify the correctness/incorrectness of these generated outputs. This information may be fed back into the AI computer models, such as 322-324, 340, and the like, as additional training examples with corresponding ground truth labels generated based on the user feedback input. Once a sufficient number of additional training examples are generated through the feedback engine 350, a retraining of the AI computer models may be initiated.

Thus, the illustrative embodiments provide an SRI AI-based monitor that performs operations to evaluate changes to code, or even new code, to distinguish benign code, or changes in code, from changes that are likely to be malignant. Moreover, the SRI AI-based monitor distinguishes between changes that are functional and changes that are non-functional. As a result, not all changes that are unable to be authenticated will cause a failure, as in the brittle SRI mechanisms. Instead, a more intelligent evaluation is performed and thus, changes that may otherwise cause existing SRI mechanisms to instigate a failure, may be found to be benign and permitted without failure with the SRI AI-based monitor of the illustrative embodiments.

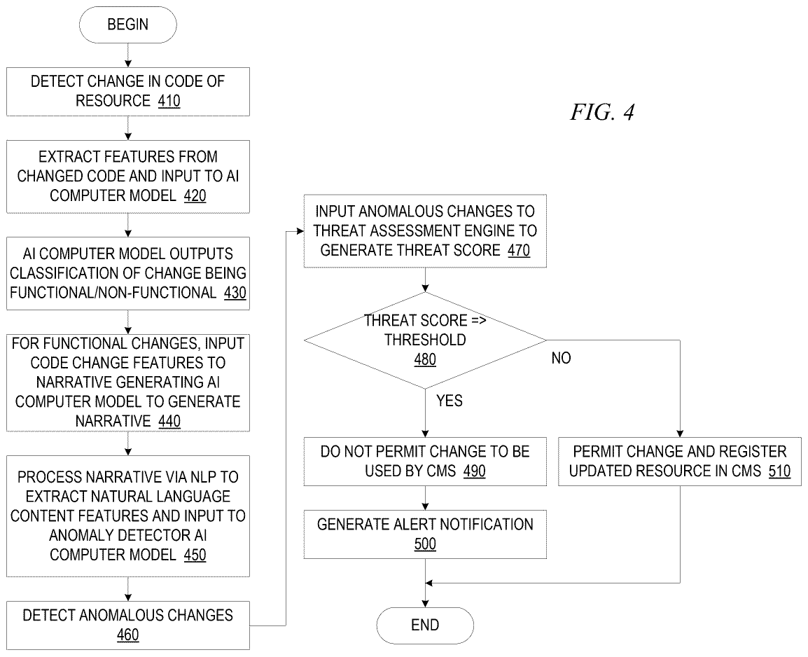

FIG. 4 is a flowchart outlining an example operation of an SRI AI-based monitor in accordance with one illustrative embodiment. It should be appreciated that the operations outlined in FIG. 4 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 4, and may, in some cases, make use of the results generated as a consequence of the operations set forth in FIG. 4, the operations in FIG. 4 themselves are specifically performed by the improved computing tool in an automated manner.

As shown in FIG. 4, the operation starts by detecting a change to the code of a resource (step 410). The features are extracted from the changed code and are input to an AI computer model (step 420). The AI computer model outputs a classification of whether the change is functional or non-functional (step 430). For functional changes, the features of the changed code are input to a narrative generating AI computer model which generates a natural language narrative description of the change in the code (step 440). The narrative is processed by a NLP AI computer model to extract features of the natural language content which are input to an anomaly detector AI computer model (step 450). The anomaly detector AI computer model processes the natural language content features along with information from resources and historical change database to detect anomalous changes (step 460).

The anomalous changes are input to a threat assessment engine which generates a threat score for the change described in the narrative (step 470). The threat score is compared to a threshold (step 480) and if the threat score is equal or higher than the threshold, the change is not permitted to be used by the content management system (step 490) and an alert notification is generated (step 500). Otherwise, the change is permitted and the change is registered with the content management system for subsequent (step 510). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
detecting a code change in code of a resource;
processing, by a first artificial intelligence (AI) computer model, features of the detected code change as input to generate a classification of the code change as being either functional or non-functional; and
in response to the code change being classified as functional:
generating, by a second AI computer model, a natural language narrative description of the code change;
processing, by a third AI computer model, the natural language narrative to extract features based on a computer natural language processing (NLP) of the natural language narrative to determine a threat level of the code change; and
registering or denying registration of the code change in a content management system (CMS) based on the threat level of the code change.

2. The method of claim 1, further comprising, in response to the code change being classified as functional, and in response to determining that the threat level of the code change is benign, updating a hash value of the code of the resource to be a new hash value corresponding to the changed code of the resource.

3. The method of claim 1, wherein detecting a code change in code of a resource comprises executing a difference command on code in an inventory catalog to extract line-by-line changes in the code.

4. The method of claim 1, wherein the second AI computer model generates the natural language narrative description based on a classification of the code change and context information about a type of function changed by the code change.

5. The method of claim 1, wherein the second AI computer model is a transformer-based natural language processing AI computer model.

6. The method of claim 1, wherein the third AI computer model determines, based on the extracted features from the natural language narrative, whether the code change deviates from historical patterns of code changes to resources and classifies the code change to be malicious if the code change deviates from historical patterns of code changes.

7. The method of claim 1, wherein the second AI computer model is trained through a machine learning training process on training data comprising examples of narratives and corresponding ground truth labels specifying a proper classification of the changes described in the examples of narratives, and wherein the first AI computing model is trained to recognize patterns of input features that correspond to at least one of malign or benign changes to code.

8. The method of claim 1, wherein processing, by the third AI computer model, the natural language narrative to extract features based on the computer NLP of the natural language narrative to determine the threat level of the code change comprises:
comparing the code change against a database of known code change patterns based on a semantic similarity matching, wherein the known code change patterns specify at least one of known vulnerabilities or known acceptable modifications; and
determining a threat level based on a degree of matching of the code change to known code change patterns.

9. The method of claim 1, wherein the threat level of the code change is calculated as a weighted function of a plurality of scores capturing different aspects of the code change.

10. The method of claim 9, wherein the plurality of scores comprise at least one of:
an Anomaly_Score that indicates how different the code change is from expected code changes;
a Pattern_Match_Score that indicates how much the code change matches known patterns indicative of malicious code;
a Source_Auth_Score that indicates how reliable a source of the code change is; or
a Historical_Deviation_Score that indicates how much the code change deviates from previous historical code changes made to resources.

11. A computer program product comprising:
one or more computer-readable storage media; and
program instructions stored on the one or more computer-readable storage media to perform operations comprising:
detecting a code change in code of a resource;
processing, by a first artificial intelligence (AI) computer model, features of the detected code change as input to generate a classification of the code change as being either functional or non-functional; and
in response to the code change being classified as functional:
generating, by a second AI computer model, a natural language narrative description of the code change;
processing, by a third AI computer model, the natural language narrative to extract features based on a computer natural language processing (NLP) of the natural language narrative to determine a threat level of the code change; and
registering or denying registration of the code change in a content management system (CMS) based on the threat level of the code change.

12. The computer program product of claim 11, wherein the operations further comprise, in response to the code change being classified as functional, and in response to determining that the threat level of the code change is benign, updating a hash value of the code of the resource to be a new hash value corresponding to the changed code of the resource.

13. The computer program product of claim 11, wherein detecting a code change in code of a resource comprises executing a difference command on code in an inventory catalog to extract line-by-line changes in the code.

14. The computer program product of claim 11, wherein the second AI computer model generates the natural language narrative description based on a classification of the code change and context information about a type of function changed by the code change.

15. The computer program product of claim 11, wherein the second AI computer model is a transformer-based natural language processing AI computer model.

16. The computer program product of claim 11, wherein the third AI computer model determines, based on the extracted features from the natural language narrative, whether the code change deviates from historical patterns of code changes to resources and classifies the code change to be malicious if the code change deviates from historical patterns of code changes.

17. The computer program product of claim 11, wherein the second AI computer model is trained through a machine learning training process on training data comprising examples of narratives and corresponding ground truth labels specifying a proper classification of the changes described in the examples of narratives, and wherein the first AI computing model is trained to recognize patterns of input features that correspond to at least one of malign or benign changes to code.

18. The computer program product of claim 11, wherein processing, by the third AI computer model, the natural language narrative to extract features based on the computer NLP of the natural language narrative to determine the threat level of the code change comprises:
comparing the code change against a database of known code change patterns based on a semantic similarity matching, wherein the known code change patterns specify at least one of known vulnerabilities or known acceptable modifications; and
determining a threat level based on a degree of matching of the code change to known code change patterns.

19. The computer program product of claim 11, wherein the threat level of the code change is calculated as a weighted function of a plurality of scores capturing different aspects of the code change.

20. A computer system comprising:
a processor set;
one or more computer-readable storage media; and
program instructions stored on the one or more computer-readable storage media to cause the processor set to perform operations comprising:
detecting a code change in code of a resource;
processing, by a first artificial intelligence (AI) computer model, features of the detected code change as input to generate a classification of the code change as being either functional or non-functional; and
in response to the code change being classified as functional:
generating, by a second AI computer model, a natural language narrative description of the code change;
processing, by a third AI computer model, the natural language narrative to extract features based on a computer natural language processing (NLP) of the natural language narrative to determine a threat level of the code change; and
registering or denying registration of the code change in a content management system (CMS) based on the threat level of the code change.
